(19) United States
(12) Patent Application Publication
(10) Pub. No.: US 2001/0020597 A1
(43) Pub. Date: Sep. 13, 2001

(54) Pneumatic separator having centrifugal action

(75) Inventors: Cordonnier Alain, Lille (FR); Lemaire Danielle, Villeneuve D' Ascq (FR)

Correspondence Address: Harrison & Egbert, 7th Floor, 412 Main Street, Houston, TX, 77002, US

(73) Assignee: FCB Societe Anonyme

(21) Appl. No.: 09/835,150

(22) Filed: Apr. 16, 2001

Related U.S. Application Data
(62) Division of application No. 09/202,471, filed on Dec. 10, 1999.
Application No. 09/202,471 is a 371 of international application No. PCT/FR97/00678, filed on Apr. 15, 1998.

(30) Foreign Application Priority Data
Apr. 15, 1997 (FR) PCT/FR97/00678

(51) Int. Cl. B07B 4/06

(52) U.S. Cl. 209/154; 209/714

(57) ABSTRACT

Centrifugal action type pneumatic separator comprising a rotor with a vertical axis provided with vanes regularly distributed over its periphery, guide blades disposed about the rotor and a housing containing the rotor and the guide blades and provided with inputs for the air and for the material to be graded, with an evacuation conduit for the air laden with the fine fraction of the material and with an output for the coarse fraction, with the air penetrating the rotor at its periphery via the channels (15) formed between the vanes, and flowing inside the rotor towards the evacuation conduit.

To be able to modify the grain size distribution of the particles in the finished product, the air flowing in the rotor is divided into at least two separate streams, and the rotor is equipped with means (28) for adjusting the speed and/or the flow rate of at least one of the streams.

The present invention relates to a pneumatic separator having a centrifugal action designed to grade or classify a granular material into a fine fraction and a coarse fraction and comprising a rotor with a vertical axis provided with vanes regularly distributed over its periphery, guide blades disposed about the rotor, along the generating lines of a fictitious cylinder, and capable of imparting to a stream of air or another gas penetrating the said fictitious cylinder a movement of rotation about the axis of the said cylinder, and a housing in which are enclosed the rotor and the guide blades and which is equipped with one or more inputs for the air and for the material to be graded, with an output orifice disposed above or below the rotor and through which is sucked the stream of air laden with the fine fraction of the material, and with at least one output for the coarse fraction, with the air penetrating the rotor at its periphery, via the channels formed between the vanes, and circulating inside the rotor towards the output orifice.

In a separator of this type, the material to be graded and the air stream can introduced separately inside the space with an annular section delimited by the guide blades and the rotor, or the material to be graded can be placed in suspension in the air stream before the latter is admitted into the said space, through the blades; the air stream then penetrates the rotor and is evacuated via the output orifice.

In both cases, the air stream and the material to be graded are subjected to rotation, about the axis of the rotor, in the space with an annular section contained between the rotor and the guide blades. The particles forming the coarse section of the material are projected by the centrifugal force generated by this rotation against the guide blades and drop through the effect of gravity into a collecting hopper provided with an evacuation orifice, while the particles forming the fine fraction are entrained by the air stream through the rotor and the central output orifice.

The fine fraction that is separated contains practically all the particles the size of which is smaller than a first dimension, while the coarse fraction contains practically all the particles the size of which is larger than a second dimension, which is larger than the first one. In addition, the two fractions contain particles the size of which is between the first and second dimensions. This is reflected by a distribution curve comprising two substantially horizontal portions linked by an inclined portion the slope of which characterises the separator.

The distribution of the particles of intermediate size in one or the other of the fractions characterises the cut-off precision of the separator. In general, it is attempted to obtain, by construction, a cut-off that is as marked as possible between the two fractions, that is to say to reduce the interval between the first and second dimensions, which is reflected by a distribution curve with a steep slope.

In certain cases, the product that it is sought to obtain has to have a grain size distribution that differs from that of the fraction, whether fine or coarse, obtained by means of a separator of this type. This applies particularly to cement obtained by compression grinding the clinker. Hitherto, the only solution to this problem was to use two separators placed in series or in parallel and adjusted to the different cut-off dimensions. This represents a costly solution.

The object of the present invention is to perfect separators of the type concerned so that it is possible to adjust the slope of the distribution curve in a simple manner, that is to say to modify the grain size distribution of the particles the size of which is between the first and second dimensions.

The separator according to the invention is characterised in that the air circulating through the rotor is divided into at least two separate streams, and the rotor is equipped with means for adjusting the speed and/or the flow rate of at least one of the streams.

If the speeds of the two air streams through the channels provided between the vanes of the rotor are adjusted to different values, the drag forces exerted by the two streams upon a particle of a given mass and given dimensions will differ; in the channels through which the air stream flows at a reduced speed, the balance between the drag forces and the centrifugal forces, which corresponds to the theoretical cut-off mesh, will occur for a smaller particle dimension than that for which the said balance occurs in the other channels, through which the air speed is higher. Everything will thus take place as if there were two separators in parallel having different cut-off meshes; by adjusting the speeds of the air streams, the cut-off meshes can be adjusted and, consequently, the grain size distribution of the particles in the finished product.

The means for adjusting the speed and/or the flow rate of the air streams can be formed by means for varying the input section of at least some of the channels provided between the vanes of the rotor and/or by means for varying the passage sections of the openings through which the air streams escape from the rotor.

According to a particular form of embodiment, the rotor is divided into sectors by radially disposed vertical partitions, and each sector communicates with the air output orifice via an opening provided with means for adjusting the passage section which can be formed, for example, by pivoting flaps or diaphragms; in this form of embodiment, the radial partitions perform the anti-vortex function of the second set of vanes of the separator according to French patent No. 90 01673 in the name of the applicant.

To vary the section of the channels formed between the vanes of the rotor, use can be made of the plates disposed in the said channels, each plate being movable, for example, by rotation about an axis parallel to the axis of the rotor, between a first position, wherein it leaves practically all of the section of the respective channel free, and a second position, wherein it closes off the channel practically completely.

It can be chosen, for example, to place at the channel output two plates pivotally mounted on a vertical axis disposed in the median plane of the channel; these plates can be brought, via an appropriate mechanism, from a first position in which they are pressed against one another and disposed practically in the said median plane, to a second position, in which their free ends abut the ends of the vanes delimiting the channel.

Alternatively, some vanes of the rotor can be orientatable about vertical axes so that their ends can come to bear against a neighbouring vane to close off the channel that they delimit.

Another solution is to produce the vanes in two portions; a fixed part and mobile portion, orientatable by rotation about a vertical axis. For example, one of the faces of the vane can be fixed, and the other mobile and capable of pivoting about a vertical axis located close to the periphery of the rotor so as to come to bear on the neighbouring vane to close off the channel that they form. According to another form of embodiment, the radially external portion of the vane can be fixed, and its internal portion rotary, the mobile portions of two neighbouring vanes being able to be brought into abutment with one another to close the channel delimited by the two vanes.

Further characteristics of the object of the invention will emerge from a study of the following description, which refers to the accompanying drawings, which show, by way of a non-limitative example, several forms of embodiment of the invention. In these drawings:

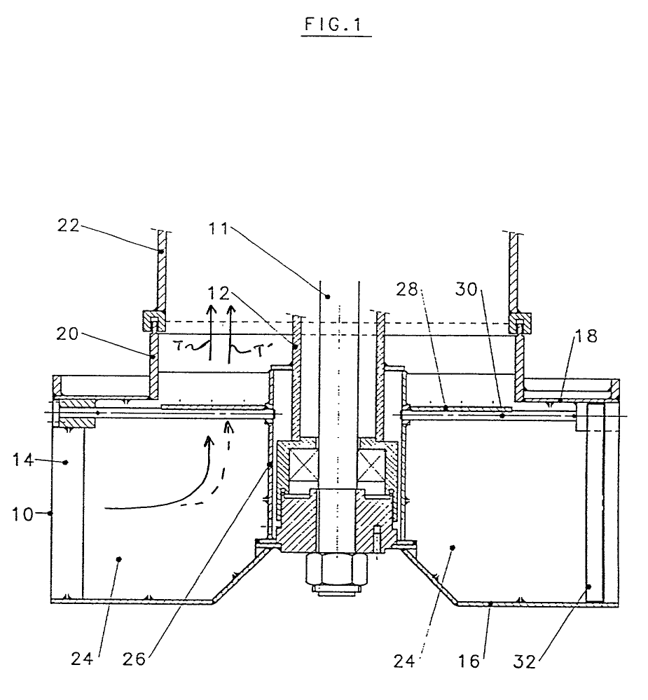

FIG. 1 is a diametrical sectional view of a separator rotor according to the invention;

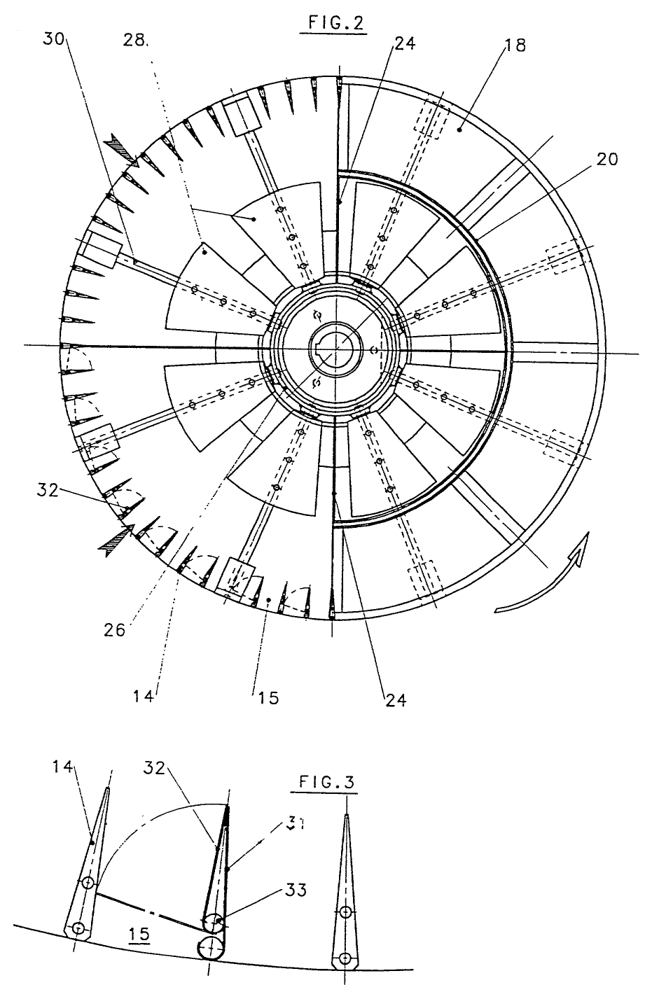

FIG. 2 is a top view of the rotor of FIG. 1, with the ring partially closing the rotor at its upper portion removed over half of the rotor;

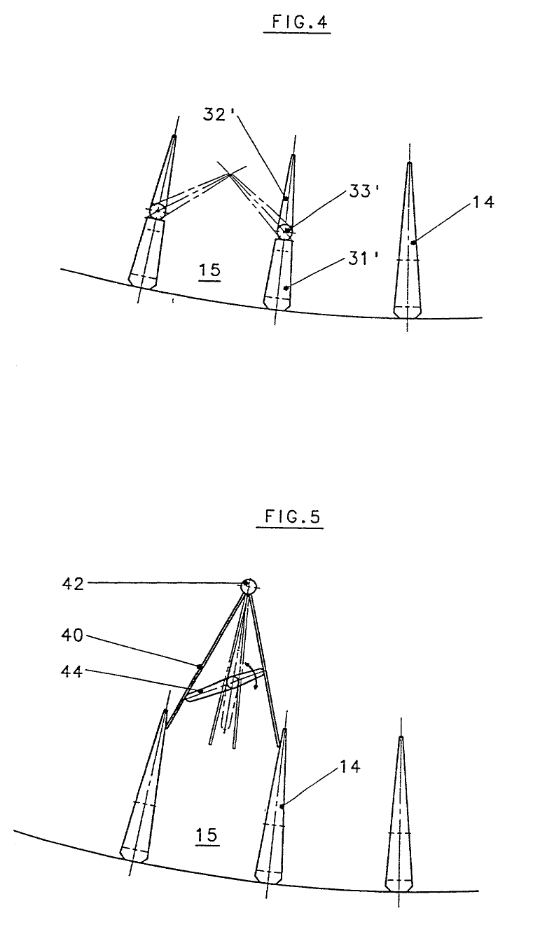

FIG. 3 is a larger scale view of a detail of the rotor;

FIGS. 4 and 5 are views analogous to that of FIG. 3, illustrating alternative forms of embodiment;

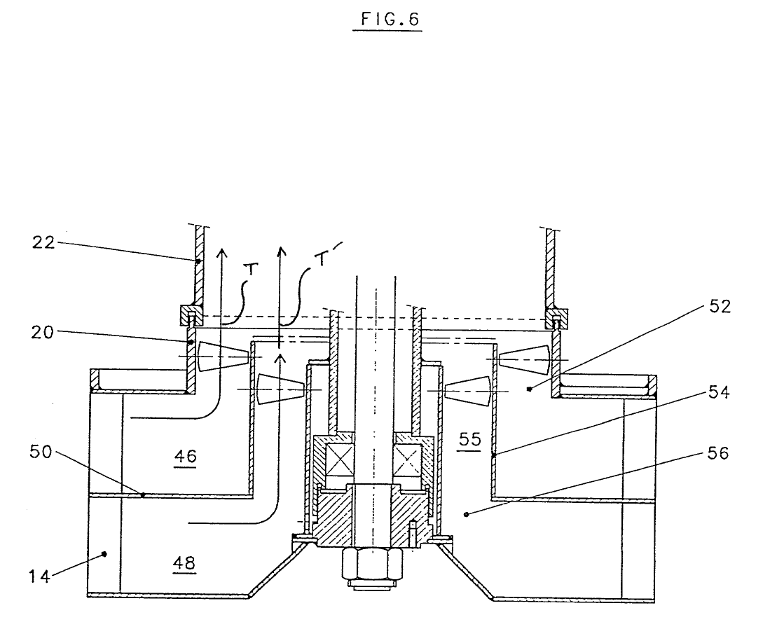

FIG. 6 is a diametrical sectional view of another separator rotor according to the invention; and

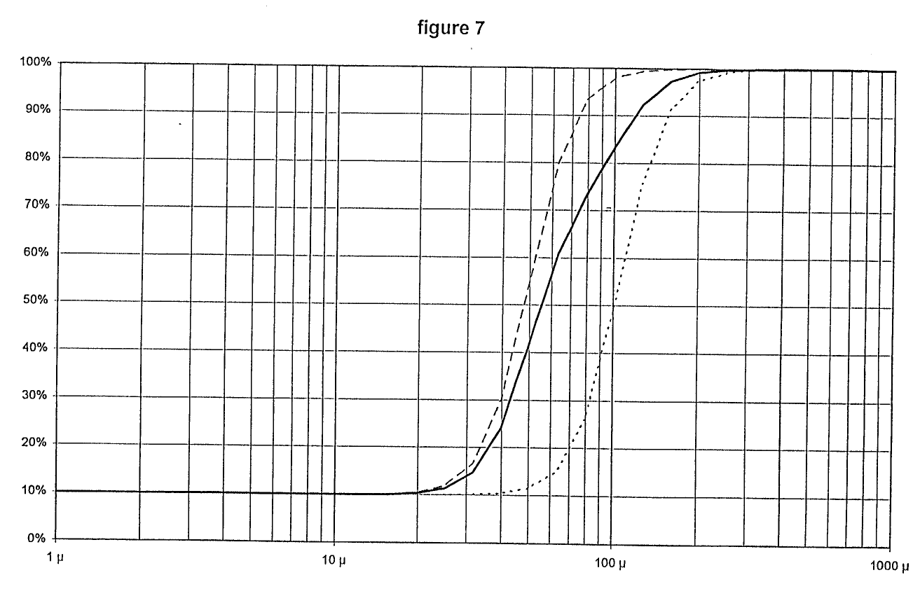

FIG. 7 shows the distribution curves of a conventional separator and of the separator according to the invention.

The separator according to the invention is of the type disclosed in French patent No. 90.01673, to which reference can be made for further details. As described above, it comprises a rotor with a vertical axis, guide blades disposed about the rotor and a housing within which are enclosed the rotor and the guide blades, and which is provided with one or more inputs for the product to be graded and for the air stream, one or more outputs for the coarse fraction and a central output orifice for the air stream laden with the fine fraction of the product.

The rotor 10 is fixed to the lower end of a vertical shaft 11 mounted, via roller bearings, in a tubular support 12 fixed to the roof of the separator housing. The shaft is coupled to a variable speed control unit enabling the rotor to be rotated at the desired speed.

The rotor comprises a large number of vertical vanes 14 regularly spaced over its periphery, and the lower and upper ends of which are fixed, respectively, to an end portion 16 and to a ring 18. A cylindrical shell 20, fixed to the internal edge of the ring 18, defines an output passage for the air laden with particles of small dimensions that have penetrated the rotor via the channels 15 provided between the vanes 14. This shell is connected, via a rotating joint, to the lower end of an evacuation conduit 22 passing through the roof of the separator housing.

The interior of the rotor is divided into four equal sectors by four radially disposed vertical partitions 24. These partitions are fixed to the end portion 16, to ring 18 and to a shell 26 surrounding the lower portion of tubular support 12, and itself fixed to end portion 16.

The output opening delimited by ring 18 and shell 26 is partially closed off by pivoting flaps 28 (two per sector in the form of embodiment shown). Each flap is fixed to a shaft 30 mounted on bearings fixed to ring 18 and shell 26. A square element provided on the outer end of each shaft 30 enables the orientation of the flaps to be adjusted and, consequently, the section of the output opening of the respective sectors, and a locking system enables the flaps to be maintained in the desired position, after adjustment.

In the sector of the rotor represented on the lower left-hand portion of FIG. 2, one vane 14 out of two is formed by a fixed portion 31 constituting the active face and a mobile portion 32 orientatable about a vertical axis 31 located close to the leading edge of the vane (see FIG. 3). This portion 32 is displaceable, between a first position (shown by a solid line in FIG. 3) where it is pressed against the fixed portion 31 of the vane, in such a way as to leave the input of canal 15 free, and a second position (shown in dot and dash lines) where it completely closes of this input. The orientation of the mobile portions of the vanes can be controlled individually or in groups. These two-part vanes must be distributed over the periphery of the rotor in such a way that the latter is balanced. For example, two diametrically opposed sectors of the rotor could be equipped therewith.

FIG. 4 shows another form of embodiment of the means for closing off certain channels 15 of the rotor. According to this alternative embodiment, the two vanes delimiting a channel are in two portions an external portion 31′ which is rigidly fixed to the structure of the rotor, and a lower portion 32′, which is capable of pivoting about a vertical axis 33′. A control mechanism, not shown, enables the mobile portion 32′ of each vane to be displaced between two positions: a first position, shown in solid lines in FIG. 4, wherein the portions 31′ and 32′ are in the prolongation of one another and channel 15 is completely clear, and a second position, shown in dot and dash lines, wherein the free ends of portions 32′ of the two vanes are in abutment with one another, and channel 15 is closed off.

In the alternative embodiment of FIG. 5, the channel closing means are formed by pairs of vertical plates 40 placed inside the rotor, the two plates of a pair hinged by their internal edges on the same vertical axis 42 disposed in the median plane of the channel. A cam 44 placed between the two plates, and controlled by an appropriate mechanism enables the two plates to be moved apart to bring their free ends in abutment against vanes 14 and to close off the output of channel 15, as shown in solid lines in the figure. When the cam is rotated to bring it into the median plane of the channel, plates 40 are pressed against the cam by centrifugal force, as shown in dot and dash lines in the figure, and the output of channel 15 is almost completely clear.

According to an alternative embodiment, not shown, some vanes 14 could be orientatable by being mounted in such a way as to be able to pivot on the rotor about vertical axes located close to their leading edges and to come into abutment against the fixed or orientatable neighbouring vanes to close of the corresponding channels 15.

When in service, the separator is incorporated in a circuit, open or closed, through which flows a stream of gas, for example an air stream. On penetrating the rotor, the air stream divides into as many elementary streams as there are channels 15 between the vanes 14. At the output from the channels, these elementary streams group together in each sector of the rotor into four secondary streams which escape through the output opening delimited by ring 18 and shell 26. If all the flaps 28 are in the vertical position and if all channels 15 are open, the flow rates of the four secondary streams are equal and the speeds of the elementary streams are equal; the operation of the separator is the same as that of a conventional separator.

If one part of channels 15 is closed off in one of the sectors of the rotor and, simultaneously, flaps 28 are partially closed in the other sectors, so that the air stream divides into two different streams such that the flow rate passing through each of the sectors of which flaps 28 are closed is less than the flow rate passing through the sector the flaps of which are open, the speed of the air through channels 15 that have remained open in the first sector will be, for these two reasons, higher than in the channels in the other sectors. Since the drag forces that are exerted on the particles and oppose the centrifugal force in channels 15 depend on the speed of the air, while the centrifugal forces depend only on the speed of rotation of the rotor, the dimension of the particles for which the centrifugal and drag forces are balanced (theoretical cut-off mesh) will be greater in the first sector than in the others. Everything takes place as if there were two separators in parallel working with different cut-off meshes and the fine fractions of which were mixed at the output from the separator. By adjusting the air input section in one or more sectors of the rotor and by adjusting the flow rates of air circulating in the different sectors, it is possible to select two different cut-off meshes, or more, thus enabling the desired grain size distribution to be obtained in a given range.

FIG. 7 shows, by way of example, the distribution curves of a conventional separator for two cut-off meshes, and of a separator according to the invention. The distribution curve gives the weight proportion, expressed in %, of the particles of a given size in the coarse fraction; an inverse curve would be obtained for the fine fraction. For the dimensions of particles smaller than 20 μm and greater than 200 μm, the three curves merge. In the 20-200 μm range, the dashed curve corresponds to a conventional separator the theoretical cut-off mesh of which is 50 μm, the dotted curve corresponds to a conventional separator the theoretical cut-off mesh of which is 105 μm. The solid line curve was obtained with the separator according to the invention; it can be seen that its slope is less steep than that of the conventional separators, which means that, in the 20-200 μm range, the grain sizes have a greater spread.

The invention thus makes it possible to have a distribution curve with an adjustable slope and, consequently, to obtain a finished product having the desired grain size distribution in a given grain size range by acting both on the speed of the rotor and on the orientation of the guide blades, on one hand, and on the positions of the flaps 28 and on the settings of the channel 15 sections, on the other hand.

Instead of being divided into sectors by radial partitions, the rotor could be designed as shown in FIG. 6 and divided into two portions 46, 48, by a horizontal partition 50 located, for example, at mid-height, an opening 52 provided in the upper wall of the rotor causing the upper portion of the rotor to communicate with air evacuation conduit 22 of the separator, and a shell 54, the diameter of which is less than that of the said opening 52, being connected to a central opening 56 in the partition and delimiting a passage 55 placing the lower portion of the rotor in communication with evacuation conduit 22 via the first opening. The rotor is provided with means such as those illustrated by FIGS. 3, 4 and 5 for closing off some of the channels provided between its vanes, over at least a part of their height, and with means such as flaps 28 for adjusting at least one of the output openings. According to the same principle, the rotor could be divided into more than two superposed portions. It would even be possible to do away with the horizontal partition or partitions, with the division of the air into two or more streams in the rotor resulting from the arrangement of one or more plunger tubes placed in the axis of the rotor.

Means other than pivoting flaps, for example diaphragms, could be used to adjust the sections of the output openings of the rotor. It goes with saying that these modifications and all those that can be made to the forms of embodiment described, through the use of equivalent technical means, are included within the scope of the invention.

1. Centrifugal action type pneumatic separator comprising a rotor with a vertical axis provided with vanes regularly distributed over its periphery, guide blades disposed about the rotor and a housing containing the rotor and the guide blades and provided with inputs for the air and for the material to be graded, with an evacuation conduit for the air laden with the fine fraction of the material and with an output for the coarse fraction, with the air penetrating the rotor at its periphery, via the channels formed between the vanes, and flowing inside the rotor towards the evacuation conduit, characterised in that the air flowing in the rotor is divided into at least two separate streams, and the rotor is equipped with means for adjusting the speed and/or the flow rate of at least one of the streams.

2. Separator according to claim 1, characterised in that the said rotor is equipped with means (32, 32′, 40) for varying the section of at least some of the channels (15) via which one of the air streams penetrates the interior of the rotor.

3. Separator according to claim 1 or 2, characterised in that the said rotor is equipped with means (28) for varying the section of the opening via which at least one of the air streams escapes from the rotor towards the evacuation conduit (22).

4. Separator according to claim 1, 2 or 3, characterised in that the rotor is divided into sectors by radially disposed vertical partitions (24) and each sector communicates with the output passage via an opening provided with means (28) for adjusting the section of the air passage.

5. Separator according to claim 1, 2 or 3, characterised in that the rotor is divided into two portions (46, 48) by a horizontal partition (50), in that the portion (48) of the rotor furthest from the evacuation conduit (22) communicates with the latter via a passage (55) delimited by a coaxial shell (54) connected to a central opening (56) in the said partition, in that the other portion (46) of the rotor communicates with the said evacuation conduit via an annular opening (52) surrounding shell, and in that means are provided for varying the section of at least some of the channels provided between the vanes (14) in at least one of the portions of the rotor and for varying the section of the said passage (55) and/or of the said annular opening (52).

6. Separator according to claim 4 or 5, characterised in that the said means for adjusting the section of the said opening and/or the said passage, are formed by pivoting flaps (28).

7. Separator according to claim 4 or 5, characterised in that the said means for adjusting the section of the said opening and/or the said passage are formed by diaphragms.

8. Separator according to claim 4 or 5, characterised in that the rotor is equipped with means (32, 32′, 40) for varying the section of at least some of the channels (15) formed between the vanes (14) of one of the sectors or portions of the rotor.

9. Separator according to claim 2 or 8, characterised in that the said means for varying the section of the channels are constituted by plates disposed in the said channels (15), each plate being mobile between a first position, in which it leaves practically all the section of the channel free and a second position, in which it closes off the channel practically entirely.

10. Separator according to claim 2 or 8, characterised in that the said means for varying the section of the channels are formed, in the case of each channel, by two plates (40) placed at the output of the channel (15) and mounted pivotally on a vertical axis (42) disposed in the median plane of the channel, these plates being able to be brought by an appropriate mechanism (44) from a first position, in which they are pressed against one another and disposed practically parallel to the said median plan, to a second position in which their free ends are in abutment against the ends of the vanes (14) delimiting the channel.

11. Separator according to claim 2 or 8, characterised in that some vanes (14) of the rotor are orientatable about vertical axes so that they can come to bear upon a neighbouring vane to close of the channels (15) that they form with the neighbouring vanes, these orientatable vanes forming the means for varying the section of the said channels.

12. Separator according to claim 2 or 8, characterised in that some vanes (14) of the rotor are in two portions, a fixed portion (31, 31′) and a mobile portion (32, 32′) orientatable by rotation about a vertical axis and these mobile portions of the vanes form the means for varying the section of the channels (15).

13. Separator according to claim 12, characterised in that one of the faces (31) of some vanes is fixed and the other face (32) is mobile and capable of pivoting about a vertical axis (33) located close to the periphery of the rotor to come to bear upon the neighbouring vane and close off the channel (15) that they form.

14. Separator according to claim 12, characterised in that the radially external portion (31′) of the vane is fixed and its radially internal portion (32′) is rotary, the mobile portions of two neighbouring vanes being able to be brought into abutment with one another to close off the channel delimited by the two vanes.
